(19) United States
(12) Patent Application Publication
(10) Pub. No.: US 2024/0308577 A1
(43) Pub. Date: Sep. 19, 2024

(54) Controller for a Vehicle Having a Steering Device, Steering Device, and Method for Cooling an Electric Motor for a Steering Device

(71) Applicant: KNORR-BREMSE SYSTEME FÜR NUTZFAHRZEUGE GMBH, München (DE)

(72) Inventor: Bernhard MILLER, Weil der Stadt (DE)

(21) Appl. No.: 18/277,602

(22) PCT Filed: Jan. 24, 2022
(86) PCT No.: PCT/EP2022/051497

§ 371 Date: Aug. 17, 2023

(30) Foreign Application Priority Data
Feb. 18, 2021 (DE) 10 2021 103 818.9

(51) Int. Cl. B62D 5/065; F04B 17/03; F04B 53/08

(52) U.S. Cl. CPC B62D 5/065; F04B 17/03; F04B 53/08

(57) ABSTRACT

A control unit is provided for a vehicle with a steering device having a pump device, which includes a pump and an electric motor, and a transmission device. The control unit is designed to provide the electric motor with a motor signal for operating the electric motor in order to cool the electric motor in a normal operating phase of the steering device.

### BACKGROUND AND SUMMARY

The present disclosure relates to a control unit for a vehicle with a steering apparatus, to a steering apparatus, and to a method for cooling an electric motor for a steering apparatus.

In the case of steering systems of vehicles, in particular in the case of front axle steering systems (also called power steering system) of medium and heavy utility vehicles, a recirculating ball steering mechanism can be operated, for example, by way of an external, unidirectional hydraulic pump. A connection between the pump and the steering mechanism can take place, for example, by way of an external pipe network. In addition, an external oil reservoir can be necessary as equalizing tank. Therefore, individual components of a steering system of this type can be arranged distributed in the vehicle.

DE 20 2019 101 522 U1 discloses a corresponding steering assistance apparatus for a vehicle, in particular for a utility motor vehicle.

Against this background, it is the object of the present concept to provide an improved control unit for a vehicle with a steering apparatus, an improved steering apparatus, and an improved method for cooling an electric motor.

This object is achieved by way of a control unit, by way of a steering apparatus, by way of a method, and by way of a computer product, in accordance with the independent claims.

The advantages which can be achieved by way of the presented disclosure consist in that an installation space which is required for the components of the steering device can be reduced in size.

Therefore, a control unit for a vehicle is presented with a steering apparatus which comprises a pump device, a transmission device and the control unit. The pump device has a pump for pumping a working medium to a first output connector or a second output connector of the pump device, and an electric motor for driving the pump, the electric motor being surrounded at least partially by the working medium and, in addition or as an alternative, being washed around by it or being capable of being washed around by it. The transmission device has an input shaft which can be coupled to a steering wheel, and an output shaft which can be coupled to a steering column stalk, a transmission element which can be moved in a first direction and a second direction for transmitting a torque from the input shaft to the output shaft, and a first working medium connector and a second working medium connector, the first working medium connector being connected to the first output connector for moving the transmission element with the use of the working medium in the first direction, and the second working medium connector being connected to the second output connector for moving the transmission element with use of the working medium in the second direction. Here, the control unit is configured to provide a motor signal to the electric motor for operating the electric motor in a normal operating phase of the steering apparatus for cooling the electric motor.

The vehicle can be realized, for example, as a utility vehicle, for example as a truck, which is configured to primarily transport objects. Since a vehicle of this type can have a weight of several tons, the steering apparatus which assists a steering movement of a driver of the vehicle is advantageous. The pump device can be configured, for example, to move the working medium through the steering apparatus. Here, for example, the working medium can be realized as hydraulic oil which can be configured, for example, to dissipate heat produced during operation of the electric motor. The first output connector and the second output connector can be configured, for example, to output the working medium to a line system of the steering apparatus. Here, for example, the line system can be realized in the form of hoses or tubes. The transmission element can be configured to transmit the steering movement of the driver to a wheel axle of the vehicle, in order that the wheels turn in the desired direction and, for example, a direction of travel can thus be changed. The control unit can be part of the steering apparatus which provides corresponding signals, such as, for example, the motor signal, to the electric motor of the pump device in the normal operating phase. As a result, the electric motor can advantageously be cooled in such a way that, for example, damage as a result of overheating can be avoided. The normal operating phase can be, for example, an operating state, in which the vehicle is carrying out a driving process, or else in which a vehicle engine of the vehicle is running.

In accordance with one embodiment, the control unit can be configured to provide the motor signal as a signal which can bring about a current flow through at least one motor winding of the electric motor, from which a rotation of a rotor of the electric motor results. The motor winding can also be called, for example, a coil, through which current can flow. The rotor can advantageously be realized as a rotatable rotor disk which can rotate by means of a magnetic field. Here, for example, the magnetic field can arise from the current flow which flows through the motor winding. The current flow through the motor winding should therefore be so strong that a rotation of the rotor is also actually brought about and not only heating of the lines of the rotor takes place, which heating can be used, for example, to heat the working medium in a starting stage of the operation of the steering apparatus.

Furthermore, a steering apparatus for a vehicle is presented which has a pump device with a pump for pumping a working medium to a first output connector or a second output connector of the pump device, and an electric motor for driving the pump, the electric motor being surrounded and, in addition or as an alternative, washed around at least partially by the working medium. Furthermore, the steering apparatus has a transmission device which has an input shaft which can be coupled to a steering wheel and an output shaft which can be coupled to a steering column stalk, a transmission element which can be moved in a first direction and a second direction in order to transmit a torque from the input shaft to the output shaft, and a first working medium connector and a second working medium connector. Here, the first working medium connector is connected to the first output connector in order to move the transmission element with use of the working medium in the first direction, and the second working medium connector is connected to the second output connector in order to move the transmission element with use of the working medium in the second direction. Furthermore, the steering apparatus has a control unit in one of the abovementioned variants.

The steering apparatus can be realized, for example, in a vehicle, as has been mentioned above. The steering apparatus can have, for example, the control unit in one of the above-presented variants. An installation space within the vehicle can advantageously be used efficiently as a result.

In accordance with one embodiment, the electric motor can have a motor winding which can be surrounded by the working medium. This means that, for example, the working medium can flow around the motor winding in order to advantageously dissipate heat output by the motor winding and in order to cool the motor winding as a result. Direct contact of the working medium with lines of the motor winding or a housing of the motor winding of the electric motor is particularly favorable here, in order for it to be possible for the heat generated during operation of the electric motor to be dissipated from the motor winding rapidly and efficiently.

In accordance with one embodiment, the pump and the electric motor can have a common shaft and can be arranged in a common housing. As a result, installation space can advantageously be saved, with the result that, for example, the pump device can be realized in a manner which is reduced in size.

The housing can have a channel for conducting the working medium from an inlet along an inner wall of the housing to the motor winding, it being possible for the channel to be formed to conduct the working medium around the motor winding. The working medium can advantageously dissipate the heat to be dissipated as a result of the arrangement of the channel on the inner wall of the housing, and can therefore again cool it at least to a certain extent.

In accordance with one embodiment, a rotor of the electric motor can have a plurality of permanent magnets, it being possible for mutually adjacent permanent magnets to be spaced apart by way of slots for conducting through the working medium. The working medium can advantageously flow through the slots into the channel in this way.

In accordance with one embodiment, the slots can be formed to convey the working medium in the case of a rotation of the rotor. A cooling operation can advantageously begin as a result as soon as the rotor rotates, that is to say as soon as current flows through the motor winding, a magnetic field is built up, and the permanent magnets are repelled by the magnetic field.

In accordance with one embodiment, the pump can be formed as a bidirectional hydraulic pump. As a result, the pump can advantageously pump the working medium in the first direction or the second direction depending on the steering movement.

Furthermore, the steering apparatus can have a valve which is connected between the first output connector and the second output connector. The valve can be formed, for example, to intervene in an emergency situation, for example, or to move the working medium during a warm-up phase of the latter, without an actuation of the steering column stalk taking place as a result.

In accordance with one embodiment, the electric motor cannot move the steering column stalk when the valve is open. As a result, a safety and maintenance function can be realized by way of the valve.

Furthermore, a method for cooling an electric motor for a steering apparatus in one of the above-mentioned variants is presented. Here, the method comprises a step of providing of a motor signal to the electric motor of the steering apparatus in order to operate the electric motor.

The method can accordingly be used in, for example, a utility vehicle.

This method can be implemented, for example, in software or hardware or in a mixed form of software and hardware, for example in a control unit in one of the abovementioned variants. Here, the step of one variant of the method presented here can be carried out, actuated or implemented in corresponding devices. The object on which the concept is based can also be achieved rapidly and efficiently by way of this design variant of the concept.

To this end, the control unit can have at least one computing unit for processing signals or data, at least one memory unit for storing signals or data, at least one interface to a sensor or an actuator for reading in sensor signals from the sensor or for outputting data signals or control signals to the actuator, and, in addition or as an alternative, at least one communications interface for reading in or outputting data which are embedded into a communications protocol. The computing unit can be, for example, a signal processor, a microcontroller or the like, it being possible for the memory unit to be a flash memory, an EPROM or a magnetic memory unit. The communications interface can be configured to read in or output data in a wireless and/or wired manner, it being possible for a communications interface which can read in or output wired data to read in these data, for example, electrically or optically from a corresponding data transmission line, or to output them into a corresponding data transmission line.

In one advantageous refinement, control of a method for cooling an electric motor for a steering apparatus takes place by way of the control unit. To this end, the control unit can access, for example, sensor signals such as a motor signal. The actuation takes place via actuators such as a provision unit which is configured to provide the motor signal.

Exemplary embodiments of the concept presented here will be explained in greater detail in the following description with reference to the figures.

### BRIEF DESCRIPTION OF THE DRAWINGS

FIG. 1 is a diagrammatic illustration of a vehicle with a steering apparatus and a control unit in accordance with one exemplary embodiment;

FIG. 2 is a diagrammatic cross-sectional illustration of a pump device in accordance with one exemplary embodiment; and

FIG. 3 is a flow chart of a method for cooling an electric motor for a steering apparatus in accordance with one exemplary embodiment.

In the following description of favorable exemplary embodiments of the present concept, identical or similar designations are used for the elements which are shown in the different figures and have a similar action, a repeated description of these elements being dispensed with.

### DETAILED DESCRIPTION OF THE DRAWINGS

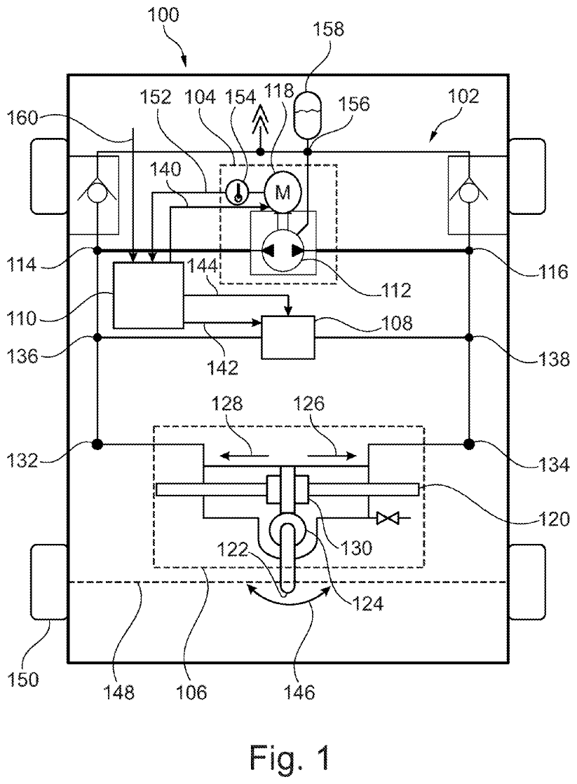

FIG. 1 shows a diagrammatic illustration of a vehicle 100 with a steering apparatus 102 in accordance with one exemplary embodiment. The vehicle 100 can be realized, for example, as a utility vehicle which is configured to mainly transport objects. Since the vehicle 100 can weigh several tons, the vehicle 100 has the steering apparatus 102. The steering apparatus 102 is configured to assist a steering operation of an occupant of the vehicle 100. To this end, the steering apparatus 102 has a pump device 104, a transmission device 106 and a control unit 110. The steering apparatus 102 merely optionally has a valve 108.

The pump device 104 comprises a pump 112 for pumping a working medium to a first output connector 114 or a second output connector 116 of the pump device 104, and an electric motor 118 which is configured to drive the pump 112. The pump 112 can be realized, for example, as a bidirectional hydraulic pump. The transmission device 106 has an input shaft 120 which can be coupled to a steering wheel and an output shaft 124 which can be coupled to a steering column stalk 122. Furthermore, the transmission device 106 has a transmission element 130 which can be moved in a first direction 126 and a second direction 128 in order to transmit a torque from the input shaft 120 to the output shaft 124. Furthermore, the transmission device 106 comprises a first working medium connector 132 and a second working medium connector 134, the first working medium connector 132 being connected to the first output connector 114 in order to move the transmission element 130 with use of the working medium in the first direction 126, and the second working medium connector 134 being connected to the second output connector 116 in order to move the transmission element 130 with use of the working medium in the second direction 128. Moreover, the steering apparatus 102 has the control unit 110 which is configured to provide a motor signal 140 to the electric motor 118 for operating the electric motor 118 in a normal operating phase of the steering apparatus 102 in order to cool the electric motor 118.

The steering apparatus 102 optionally has the valve 108 which, in accordance with this exemplary embodiment, is connected between the first output connector 114 and the second output connector 116. This means that the valve 108 in accordance with this exemplary embodiment has a first valve connector 136 and a second valve connector 138. In accordance with this exemplary embodiment, the first valve connector 136 is arranged between the first output connector 114 and the first working medium connector 132. In an analogous manner with respect thereto, the second valve connector 138 is arranged between the second output connector 116 and the second working medium connector 134 in accordance with this exemplary embodiment. The control unit 110 is optionally configured in accordance with this exemplary embodiment to provide the motor signal 140 for operating the electric motor 118 to the electric motor 118 in the normal operating phase in order to move the steering column stalk 122, and to provide a valve closing signal 144 for closing the valve 108 to the valve 108. In accordance with one alternative exemplary embodiment, the control unit 110 is configured to provide a valve opening signal 142 to the valve 108, for example in an emergency situation, in order to open the valve 108, as a result of which a steering movement is prevented. This means that the valve 108 blocks a throughflow of the working medium in the normal operating phase, with the result that this working medium is pumped through the transmission device 106 in accordance with this exemplary embodiment and transmits a steering direction 146, predefined by the driver of the vehicle 100, via a steering rod 148 to vehicle wheels 150.

In accordance with this exemplary embodiment, the input shaft 120 is configured, for example, to introduce a torque from a steering column (not shown here) of the vehicle 100, to which the input shaft 120 can be connected or is connected, into the steering apparatus 102. The torque which is introduced via the input shaft 120 can also be called an input torque. In accordance with this exemplary embodiment, the input shaft 120 is connected or mechanically coupled via the steering column of the steering system to a steering wheel (not shown here) of the vehicle 100. In accordance with this exemplary embodiment, the output shaft 124 is configured to discharge the torque from the steering apparatus 102 or to output the torque to the steering column stalk 122. The torque which is discharged by the output shaft 124 can also be called an output torque or an output force. In accordance with this exemplary embodiment, the transmission element 130 is configured to transmit the torque mechanically from the input shaft 120 to the output shaft 124 and/or to convert the input torque into the output torque.

Furthermore, in accordance with this exemplary embodiment, the control unit 110 is configured to provide the motor signal 140 as a signal which brings about a current flow through a motor winding of the electric motor 118, from which current flow a rotation of a rotor of the electric motor 118 results. In accordance with this exemplary embodiment, the control unit 110 is optionally configured to read in, for example, a temperature signal 152 which indicates a temperature. In accordance with this exemplary embodiment, the temperature signal 152 is provided to the control unit 110 by a temperature sensor 154 such as, for example, a thermometer. In accordance with this exemplary embodiment, the temperature sensor 154 is realized or can be realized as part of the pump device 104. As an alternative, the temperature sensor 154 can also be arranged in the vehicle 100 in some other way. Furthermore, the pump device 104 optionally has an input connector 156, via which the pump device 104 in accordance with this exemplary embodiment is connected to a reservoir vessel 158 for storing the working medium. In accordance with this exemplary embodiment, furthermore, the control unit 110 is configured to activate the normal operating phase in response to a start signal 160 which indicates, for example, a cold start of the vehicle 100.

In other words, a possibility is presented to cool the electric motor 118 by means of oil recirculation. This means that, for an application for steering a vehicle, for example a truck, an electrohydraulically operating steering gear which is called a transmission device 106 here is actuated, for example, via a bidirectionally operating pump device 104 with, for example, a hydraulic pump. The two connectors of the pump device 104 which are called first output connector 114 and second output connector 116 here are connected to the transmission device 106, more precisely to at least one cylinder of a classically known steering gear. The electric motor 118 which drives the pump 112 is surrounded by the working medium of the reservoir vessel 158 which is also called a storage vessel or expansion vessel. Here, the waste heat of the electric motor 118 is discharged via the working medium, the electric motor 118 also being used for the oil recirculation.

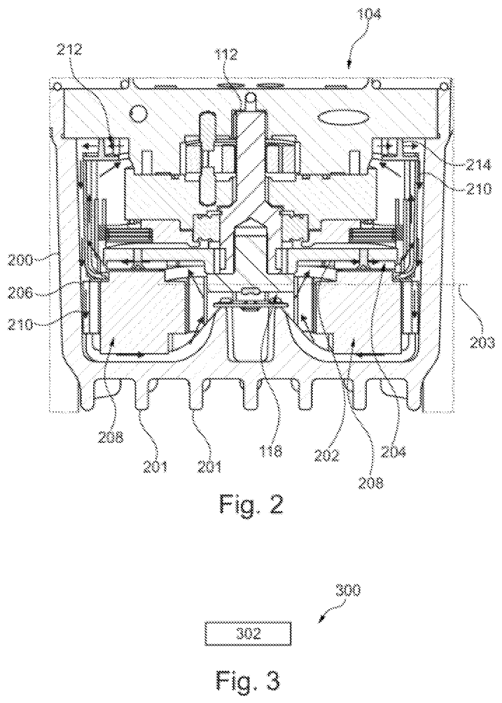

FIG. 2 shows a diagrammatic cross-sectional illustration of a pump device 104 in accordance with one exemplary embodiment. The pump device 104 which is shown here can be similar to or correspond to the pump device 104 described in FIG. 1. In accordance with this exemplary embodiment, the pump 112 is arranged centrally in the pump device 104 and is connected fixedly to the electric motor 118. Here, the pump 112 and the electric motor 118 are arranged in a housing 200 which encloses both the pump 112 and the electric motor 118 which have a common shaft. In accordance with this exemplary embodiment, the housing 200 has a plurality of fins 201 on an outer wall, which fins 201 are configured to amplify a cooling effect. As a consequence, they are configured to improve an increase in a surface area of the housing 200, in order to transmit the heat to the surrounding area.

On a side which faces the electric motor 118, the pump 112 is connected in a cover-like manner to a T-shaped coupling point of the electric motor 118. At this coupling point, a rotor 202 of the electric motor 118 is arranged on an axis 203 which is oriented perpendicularly with respect to the pump 112. Here, the rotor 202 is formed, for example, as a rotor disk which rotates around the pump 112 in the normal operating phase. In accordance with this exemplary embodiment, the rotor 202 in turn has a plurality of permanent magnets, mutually adjacent permanent magnets being spaced apart by way of slots 204 for conducting through the working medium. Here, the slots 204 are formed to convey the working medium during a rotation of the rotor 202. In accordance with this exemplary embodiment, the housing 200 has a channel 206 for conducting the working medium from an inlet along an inner wall of the housing 200 to a motor winding 208 (not shown here) of the electric motor 118. Here, the channel 206 is formed to conduct the working medium around the motor winding 208. A flowing direction of the working medium is illustrated here by way of the depicted arrows 210. In accordance with this exemplary embodiment, it is likewise illustrated as a result that the motor winding 208 is surrounded by the working medium, in order to make satisfactory thermal coupling possible, for example. In summary, the pump 112 pumps the working medium, starting from a pump output 212, through the channel 206 along a wall of the housing 200, where the working medium cools in accordance with one exemplary embodiment, in the direction of the motor windings 208. From there, in accordance with this exemplary embodiment, the working medium flows around the motor winding 208 and through the slots 204 in the direction of the housing wall as far as the pump output 212 through, for example, a heat exchanger 214. By the motor winding 208 being energized, a magnetic field is produced in the normal operating phase. The plurality of permanent magnets are repelled by the magnetic field on account of their polarity, with the result that the rotatable rotor 202 rotates. In this way, in accordance with this exemplary embodiment, a recirculation of the working medium takes place, by way of which in turn the heat of the electric motor 118 produced in the normal operating phase is dissipated. The heat exchanger 214 is configured to make even greater thermal dissipation possible by way of the working medium which flows past this heat exchanger 214, and therefore to assist the cooling process.

Since there are only restricted cooling possibilities of the pump 112 and the electric motor 118 as a result of an integration of the electric motor 118 within the pump device 104, the concept described here is presented. Cooling performance is increased considerably in accordance with this exemplary embodiment by way of mounting of the electric motor 118 in the working medium. As a result of pumping of the working medium starting from the heat exchanger 214 close to the pump 112, the channel 206 conducts the heated working medium along an entire inner wall of the cylindrically shaped housing 200 and cools it. The working medium flows around the motor winding 208 on its further path and cools it. In accordance with this exemplary embodiment, the slots 204 between the rotating permanent magnets on the rotor 202 serve as a drive for the oil recirculation, with the result that they display the function of a circulating pump.

FIG. 3 shows a flow chart of a method 300 for cooling an electric motor for a steering apparatus in accordance with one exemplary embodiment. The steering apparatus can correspond to the steering apparatus described in FIG. 1 and, in accordance with the latter, has a pump device as has been described in FIG. 2. The method 300 is therefore configured to actuate the pump device. The method 300 provides one possibility to use the working medium for cooling of the electric motor. To this end, the method 300 comprises a step 302 of providing the motor signal to the electric motor of the steering apparatus for operating the electric motor.

If an exemplary embodiment comprises an “and/or” link between a first feature and a second feature, this is to be interpreted such that the exemplary embodiment has both the first feature and the second feature in accordance with one embodiment, and has either only the first feature or only the second feature in accordance with a further embodiment.

### LIST OF DESIGNATIONS

100 Vehicle
102 Steering apparatus
104 Pump device
106 Transmission device
108 Valve
110 Control unit
112 Pump
114 First output connector
116 Second output connector
118 Electric motor
120 Input shaft
122 Steering column stalk
124 Output shaft
126 First direction
128 Second direction
130 Transmission element
132 First working medium connector
134 Second working medium connector
136 First valve connector
138 Second valve connector
140 Motor signal
142 Valve opening signal
144 Valve closing signal
146 Steering direction
148 Steering rod
150 Vehicle wheels
152 Temperature signal
154 Temperature sensor
156 Input connector
158 Reservoir vessel
160 Start signal
200 Housing
201 Fins
202 Rotor
203 Axis
204 Slot
206 Channel
208 Motor winding
210 Arrow
212 Pump output
214 Heat exchanger
300 Method
302 Step of providing a motor signal

1.-14. (canceled)

15. An apparatus for a vehicle with a steering apparatus that includes:
a pump for pumping a working medium to a first output connector or a second output connector, an electric motor for driving the pump, the electric motor being surrounded and/or being capable of being surrounded at least partially by the working medium, and a transmission with an input shaft couplable to a steering wheel and an output shaft couplable to a steering column lever, a transmission element movable in a first direction and a second direction in order to transmit a torque from the input shaft to the output shaft, and a first working medium connector and a second working medium connector, the first working medium connector being connected to the first output connector in order to move the transmission element with use of the working medium in the first direction, and the second working medium connector being connected to the second output connector in order to move the transmission element with use of the working medium in the second direction,
the apparatus comprising:
a control unit configured to provide a motor signal to the electric motor in order to operate the electric motor, in a normal operating phase of the steering apparatus, in order to cool the electric motor.

16. The apparatus as claimed in claim 15, wherein the control unit is further configured to:
provide the motor signal as a signal which brings about a current flow through at least one motor winding of the electric motor, from which a rotation of a rotor of the electric motor results.

17. A steering apparatus for a vehicle, the steering apparatus comprising:
a pump device with a pump for pumping a working medium to a first output connector or a second output connector of the pump device, and an electric motor for driving the pump, the electric motor being surrounded and/or washed around or being capable of being washed around at least partially by the working medium;
a transmission device with an input shaft which is couplable to a steering wheel and with an output shaft which is couplable to a steering column lever, a transmission element which is movable in a first direction and a second direction in order to transmit a torque from the input shaft to the output shaft, and a first working medium connector and a second working medium connector, the first working medium connector being connected to the first output connector in order to move the transmission element with use of the working medium in the first direction, and the second working medium connector being connected to the second output connector in order to move the transmission element with use of the working medium in the second direction; and
a control unit configured to provide a motor signal to the electric motor in order to operate the electric motor in a normal operating phase of the steering apparatus in order to cool the electric motor.

18. The steering apparatus as claimed in claim 17, wherein
a motor winding of the electric motor is surrounded and/or is capable of being surrounded by the working medium.

19. The steering apparatus as claimed in claim 17, wherein
the pump and the electric motor have a common shaft and/or are arranged in a common housing.

20. The steering apparatus as claimed in claim 19, wherein
the housing has a channel for conducting the working medium from an inlet along an inner wall of the housing to the motor winding, and
the channel is formed to conduct the working medium around the motor winding.

21. The steering apparatus as claimed in claim 17, wherein
a rotor of the electric motor has a plurality of permanent magnets, and
mutually adjacent ones of the plurality of permanent magnets are spaced apart by way of slots for conducting through the working medium.

22. The steering apparatus as claimed in claim 21, wherein
the slots are formed to convey the working medium in a case of a rotation of the rotor.

23. The steering apparatus as claimed in claim 17, wherein
the pump is a bidirectional hydraulic pump.

24. The steering apparatus as claimed in claim 17, wherein
a valve is connected between the first output connector and the second output connector.

25. The steering apparatus as claimed in claim 24, wherein
the electric motor is configured not to move the steering column lever when the valve is open.

26. A method for cooling an electric motor for a steering apparatus that includes:
a pump device with a pump for pumping a working medium to a first output connector or a second output connector of the pump device, and an electric motor for driving the pump, the electric motor being surrounded and/or washed around or being capable of being washed around at least partially by the working medium; and
a transmission device with an input shaft which is couplable to a steering wheel and with an output shaft which is couplable to a steering column lever, a transmission element which is movable in a first direction and a second direction in order to transmit a torque from the input shaft to the output shaft, and a first working medium connector and a second working medium connector, the first working medium connector being connected to the first output connector in order to move the transmission element with use of the working medium in the first direction, and the second working medium connector being connected to the second output connector in order to move the transmission element with use of the working medium in the second direction,
the method comprising:
providing a motor signal, via a control unit, to the electric motor of the steering apparatus; and
operating the electric motor in accordance with the motor signal to cool the electric motor in a normal operating phase of the steering apparatus.
